(19) United States
(12) Patent Application Publication
(10) Pub. No.: US 2014/0163755 A1
(43) Pub. Date: Jun. 12, 2014

(54) SYSTEMS AND METHODS FOR IMPROVING GENERATOR EFFICIENCY IN AN ISOLATED POWER CONSUMPTION SYSTEM

(71) Applicants: David Potter, San Francisco, CA (US); Eduardo Alberto Alegria, San Mateo, CA (US); Mark Puccinelli, San Francisco, CA (US); Aaron Mineai, San Francisco, CA (US)

(72) Inventors: David Potter, San Francisco, CA (US); Eduardo Alberto Alegria, San Mateo, CA (US); Mark Puccinelli, San Francisco, CA (US); Aaron Mineai, San Francisco, CA (US)

(73) Assignee: Chevron USA Inc., San Ramon, CA (US)

(21) Appl. No.: 13/836,479

(22) Filed: Mar. 15, 2013

Related U.S. Application Data
(60) Provisional application No. 61/735,801, filed on Dec. 11, 2012.

(51) Int. Cl. G06F 1/26

(52) U.S. Cl. CPC G06F 1/26
USPC 700/287

(57) ABSTRACT

A method for improving electrical generator efficiency using a rechargeable battery includes, at a computer system, determining a load from an electrical-power consumption entity for a prospective time period; and calculating a first supply from a renewable electrical power supply source for the same prospective time period. The renewable electrical-power supply source comprises one or more photovoltaic devices, and the renewable electrical-power supply source is independent from a power grid. The method also includes quantifying a deficiency in an ability of the first supply to satisfy the load during the prospective time period; and in accordance with the quantification of the deficiency in the ability of the first supply to satisfy the load during the prospective time period: optimizing a spinning reserve schedule for a plurality of power generators to thereby make up the deficiency. The optimization of the spinning reserve schedule improves the non-renewable energy consumption.

### PRIORITY AND RELATED APPLICATIONS

This application claims priority to U.S. Provisional Patent Application 61/735,801, file Dec. 11, 2012. This application also relates to U.S. Provisional Patent Application Nos. 61/735,788, and 61/735,776, each filed Dec. 11, 2012.

All the above-identified patent applications are hereby incorporated by references in their entireties.

### TECHNICAL FIELD

The disclosed implementations relate generally to improving generator efficiency in an isolated power consumption system.

### BACKGROUND

Improving power production efficiency in an isolate power system can be challenging for several reasons.

First, in an isolate power system, power supplies are often limited to power generators. For example, because no power grid can reach a visitor center in a desolate area within the Death Valley national power, the visitor center can rely on only power generators to maintain its operation.

Second, power generators are generally inefficient, unless when working at full capacity. Power demand, however, sometimes fluctuates, and, power generators' working capacity must be adjusted accordingly, resulting in inefficient power production.

Third, in an isolate power system, both power demand and power supply can change rapidly and power shortage or surplus rampantly occurs. During a power shortage, additional power supply must be brought in, sometimes unplannedly, resulting in low power production efficiency. During a power surplus, excess power supply is dispensed without being used properly, resulting in energy waste.

Given the above background, there is clearly a need in the art for systems and methods that can improve generator efficiency in an isolated power consumption system.

### SUMMARY

The above identified difficulties are reduced or eliminated by the systems and methods disclosed herein. Systems, methods, devices, and non-transitory computer readable storage mediums for improving generator efficiency using a battery in an isolated power consumption system are disclosed herein.

In some implementations, methods are performed by a computer system having one or more processors and memory storing one or more programs executed by the one or more processors. In such methods, a load from an electrical-power consumption entity for a prospective time period is determined, and a first supply from a renewable electrical power supply source for the same prospective time period is calculated. The renewable electrical-power supply source comprises one or more photovoltaic devices, and the renewable electrical-power supply source is independent from a power grid. In these methods, a deficiency in an ability of the first supply to satisfy the load during the prospective time period is then qualified; and in accordance with the quantification of the deficiency in the ability of the first supply to satisfy the load during the prospective time period: a spinning reserve schedule for a plurality of power generators is optimized to thereby make up the deficiency. The optimization of the spinning reserve schedule improves the non-renewable energy consumption.

In some implementations, the plurality of power generators comprises a plurality of gas turbines. And the spinning reserve schedule dictates, for each respective gas turbines in the plurality of gas turbines, (i) when the respective gas turbine is fired during the prospective time period and (ii) at what level of operation the respective gas turbine is operated when fired.

In some implementations, optimizing the spinning reserve schedule for the plurality of power generators includes: (i) releasing power from an energy storage device to the electrical power consumption entity; and (ii) storing power from any combination of the power generators in the plurality of power generators in accordance with the spinning reserve schedule.

In some implementations, the energy storage device is rated for storing more than 1 megawatt-hour of power.

In some implementations, the energy storage device is a lithium iron phosphate battery.

In some implementations, the renewable electrical power supply source includes power supply from one of: a hydro-electric power source, a geo-thermal power source, or a wind turbine.

In some implementations, the first supply from the renewable electrical power supply source over the prospective time period is calculated using any combination of: (i) availability of the renewable electrical power supply source over the prospective time period, (ii) stability of the renewable electrical power supply source over the prospective time period, and (iii) a likelihood of a natural event affecting the renewable electrical power supply source over the prospective time period.

In some implementations, the natural event affecting the renewable electrical power supply source is inclement weather. In some implementations, the natural event affecting the renewable electrical power supply source is time of year or time of day.

In some implementations, the load is determined in accordance with an amount of power consumption by the electrical consumption entity during a first historical time period and a second historical time periods. In some implementations, the first historical time period is in the range of between the past day and the past ten days and the second historical time period is in the range of between the past ten minutes and the past six hours.

In some implementations, the load is determined in accordance with an integration or average amount of power consumption by the electrical consumption entity during two or more time periods; and wherein the first supply is calculated in accordance with an integration or average amount of power supply by the renewable electrical power supply source during the two or more time periods.

In some implementations, calculating the first supply from the renewable electrical power supply source uses a weather report for the prospective time period.

In some implementations, determining the load from the electrical-power consumption entity uses a weather report for the prospective time period.

In some implementations, the electrical-power consumption entity is an island, a town, a building, a city, a compound, a school, a university campus, a penitentiary, a jail, or a waste water treatment plant. In some implementations, the electrical-power consumption entity is an individual residence.

In some implementations, the spinning reserve schedule mandates that, at any given time during the prospective time period, each respective power generator in the plurality of power generators runs at (i) a full rating or (ii) is turned off.

A second aspect of the present disclosure provides a computer system includes one or more processors, memory, and one or more programs. The one or more programs are stored in the memory and are configured to be executed by the one or more processors. The one or more programs include instructions for determining a load from an electrical-power consumption entity for a prospective time period; and calculating a first supply from a renewable electrical power supply source for the same prospective time period. The renewable electrical-power supply source comprises one or more photovoltaic devices, and the renewable electrical-power supply source is independent from a power grid. The one or more programs further include instructions for quantifying a deficiency in an ability of the first supply to satisfy the load during the prospective time period; and in accordance with the quantification of the deficiency in the ability of the first supply to satisfy the load during the prospective time period: optimizing a spinning reserve schedule for a plurality of power generators to thereby make up the deficiency. The optimization of the spinning reserve schedule improves the non-renewable energy consumption.

A third aspect of the present disclosure provides a non-transitory computer readable storage medium storing one or more programs. The one or more programs comprise instructions for calculating a load prediction arising from an electrical-power consumption entity over a prospective time period. The one or more programs include instructions for determining a load from an electrical-power consumption entity for a prospective time period; and calculating a first supply from a renewable electrical power supply source for the same prospective time period. The renewable electrical-power supply source comprises one or more photovoltaic devices, and the renewable electrical-power supply source is independent from a power grid. The one or more programs further include instructions for quantifying a deficiency in an ability of the first supply to satisfy the load during the prospective time period; and in accordance with the quantification of the deficiency in the ability of the first supply to satisfy the load during the prospective time period: optimizing a spinning reserve schedule for a plurality of power generators to thereby make up the deficiency. The optimization of the spinning reserve schedule improves the non-renewable energy consumption.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 is a block diagram illustrating an isolated power consumption system, in accordance with some implementations.

FIG. 2 is block diagram illustrating example configurations of a computer system, in accordance with some implementations.

FIG. 3 is a flow chart illustrating a method for improving generator efficiency in an isolated power consumption system, in accordance with some implementations.

FIG. 4 is a flow chart illustrating a method for improving generator efficiency in an isolated power consumption system, in accordance with some implementations.

FIGS. 5A-5B are flow charts illustrating a method for improving generator efficiency in an isolated power consumption system, in accordance with some implementations.

### DETAILED DESCRIPTION

Additional details of implementations are now described in relation to the Figures.

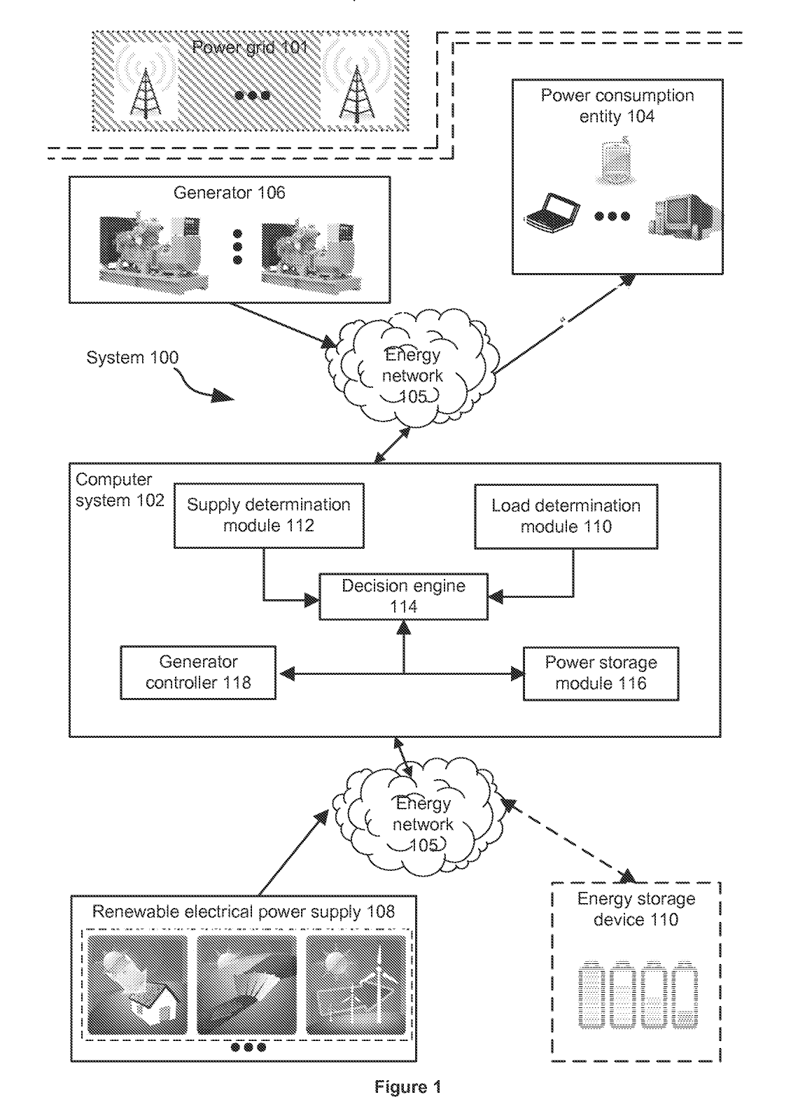

FIG. 1 is a block diagram illustrating a system 100 for improving generator efficiency in an isolated power consumption system. In some implementations, the system 100 includes a computer system 102, one or more power consumption entities 104, one or more generators 106, a renewable electrical power supply 108, and an energy storage device 110, and one or more energy networks 105 for interconnecting these components. In some implementations, the one or more generators 106 include gasoline generators, diesel generators, and natural gas generators. In some implementations, the system 100 is not connected to a power grid 101, e.g., when the system 100 is a power system on a small isolated island in the pacific ocean.

In some implementations, the computer system 102 includes a load determination module 110, a supply determination module 112, a decision engine 114, a power storage module 116, and a generator controller 118. In some implementations, the computer system 102 measures or predicts power load from one or more power consumption entities 104, as well as potential power supply from the renewable electrical power supply 108. In some implementations, the computer system 102, based on the predicted supply and load, optimizes spinning schedules for the one or more generators 106, in order to optimize non-renewable energy (e.g., diesel or gasoline) consumption.

In some implementations, the computer system 102, based on the predicted supply and load, stores electrical power (e.g., electricity) produced by the one or more generators 106, in order to bring or maintain the one or more generators into or in a optimal operation mode (e.g., when the generators are working at full spinning capacity).

In some implementations, the computer system 102 is a distributed energy resources management system (DERMS) that controls the operation of distributed energy resources (DERs)—e.g., the renewable electrical power supply 108, and advanced energy storage (AES), which includes the energy storage device 110. In some implementations, the computer system 102 operates to optimize production efficiency of a non-renewable power supply source, such as the generators 106.

In some implementations, the one or more power consumption entities 104 includes structures and equipments that consume power (e.g., electricity power), e.g., a residential or a manufacturing facility on an isolated island, a water treatment facility, a jail or penitentiary, single-family houses, condominiums, city libraries, town halls, computers, heaters, air conditioners, home appliances, industrial equipments, lights, and automatic doors.

In some implementations, the power grid 101 that independent (e.g., isolated) from the renewable electrical power supply 108 provides electrical power supplied by a utility provider, such as the PG&E company, the California ISO company, the PJM Interconnection company, and the EDISON company. In some implementations, the power grid 106 is not connected to the power system 100, temporarily or permanently. In some implementations, the power system 100 (or the power consumption entity 104) is not capable of using power supplied by the power grid 101.

In some implementations, the renewable electrical power supply 108 includes one or more alternative energy supplies, such as photovoltaic devices (e.g., PV farms), hydro-electric stations, wind farms/turbines, geysers, biomass plants, and geothermal generators.

In some implementations, the energy storage device 110 (sometimes also called advanced energy storage “AES”) includes a predefined number of individual batteries, e.g., a battery pool having 400 individual batteries, or a battery rack including 2,000 batteries. In some implementations, the energy storage device 110 is capable of providing 4 megawatt hours of electricity. In some implementations, the energy storage device 110 is configured for storing more than 1 megawatt-hour of power. In some implementations, the energy storage device 110 includes a lithium iron phosphate rechargeable battery.

In some implementations, the energy network 105 includes power lines, transmission towers, power switches, or a subset thereof, for electrical power transmission and storage. In some implementations, the energy network 105 optionally includes a computer network for transmitting control signals, e.g., between the computer system 102 and the renewable electrical power supply 108, or between the computer system 102 and the energy storage device 110. In some implementations, the energy network 105 includes the Internet, one or more local area networks (LANs), one or more wide area networks (WANs), other types of networks, or a combination of such networks.

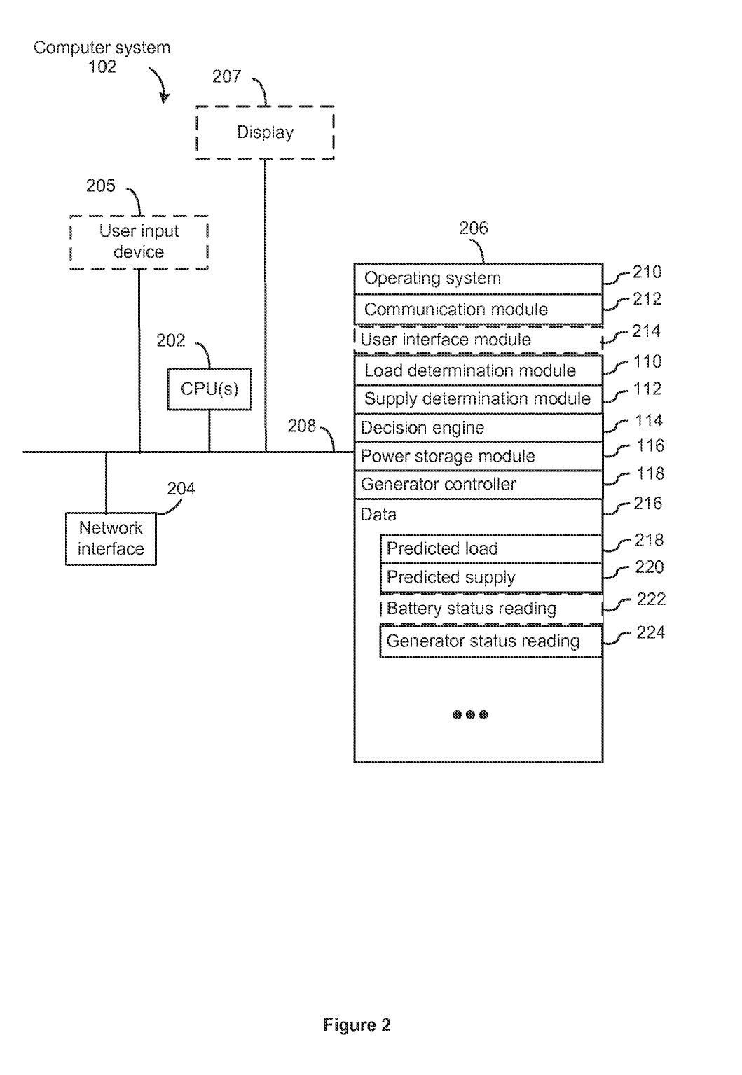

FIG. 2 is block diagram illustrating example configurations of a computer system 102 for improving generator efficiency in an isolated power consumption system, in accordance with some implementations.

The computer system 102, in some implementations, includes one or more processing units CPU(s) 202 (also herein referred to as processors, one or more network interfaces 204, one or more user input devices 205, memory 206, a display 207, and one or more communication buses 208 for interconnecting these components. The communication buses 208 optionally include circuitry (sometimes called a chipset) that interconnects and controls communications between system components. The memory 206 typically includes high-speed random access memory, such as DRAM, SRAM, or other random access solid state memory devices; and optionally includes non-volatile memory, such as one or more magnetic disk storage devices, optical disk storage devices, flash memory devices, or other non-volatile solid state storage devices. The memory 206 optionally includes one or more storage devices remotely located from the CPU(s) 202. The memory 206, or alternatively the non-volatile memory device(s) within the memory 206, comprises a non-transitory computer readable storage medium. In some implementations, the memory 206 or alternatively the non-transitory computer readable storage medium stores the following programs, modules and data structures, or a subset thereof:
an operating system 210, which includes procedures for handling various basic system services and for performing hardware dependent tasks;
a network communication module (or instructions) 212 for connecting the computer system 102 with other components in the system 100 (e.g., a computing device controlling an electrical power switch to turn on/off power supply from the renewable electrical power supply 108) via one or more network interfaces 204 (wired or wireless), or via the energy network 105 (FIG. 1);
optionally, a user interface module 214 for displaying different user interface control, for obtaining user input, and for generating control signals in accordance therewith to control the power system 100 (FIG. 1);
a load determination module 110 for predicting power load (demand) from the one or more power consumption entities 104 over a prospective time period (e.g., the next 2 hours);
a supply determination module 112 for predicting supply from the renewable electrical power supply 108 over the same prospective time period (e.g., the next 2 hours);
a decision engine 114 for controlling operations of the renewable electrical power supply 108 as well as that of the energy storage device 110;
a power storage module 114 for determining information relating to storing electrical power into or releasing electrical power from the energy storage device 110 (e.g., an amount of power to be stored in the battery, a timing thereof, a manner thereof, and subsequent transmission thereof, e.g., to which power consumption entity electricity is transmitted); and
a generator controller 118 for adjusting spinning reserve schedules for the one or more generators 106; and
data 216 stored on the computer system 102, which include:
   a predicted power load (demand) 218, which represents an estimated or predicted amount of energy, e.g., electricity, one or more power consumption entities are to consume, during a prospective time period (e.g., the next week or three hours from the current time);
   a predicted power supply 220, which represents an estimated or predicted amount of energy a renewable electrical power supply (e.g., a PV farm or a wind farm) is to provide, during a different or the same prospective time period (e.g., how many megawatt-hours electricity a wind turbine at downtown “Windy City”—Chicago—will produce, during the next week or during the next 6 hours); and
   a battery status reading 222, which includes status information of a battery, e.g., an estimated or predicted amount of energy the energy storage device 110 can store, during a different or the same prospective time period; and
   a generator status reading 224, which status information of generators, e.g., a total number generators in operation, and a spinning reserve for each of the operational generators.

In some implementations, the one or more user input devices 205 include a microphone (e.g., for voice control), a keyboard, a mouse, a touchscreen, and/or a trackpad. In some implementations, the display 207 includes a computer monitor and, optionally, a touchscreen.

The computer system 102, in some implementations, is implemented at a desktop computer. In other implementations, the computer system 102 is implemented at a mobile computing device, e.g., a smartphone, an APPLE IPAD or IPHONE, a hand-held device, such as a field testing device.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 206 optionally stores a subset of the modules and data structures identified above. Furthermore, the memory 206 may store additional modules and data structures not described above.

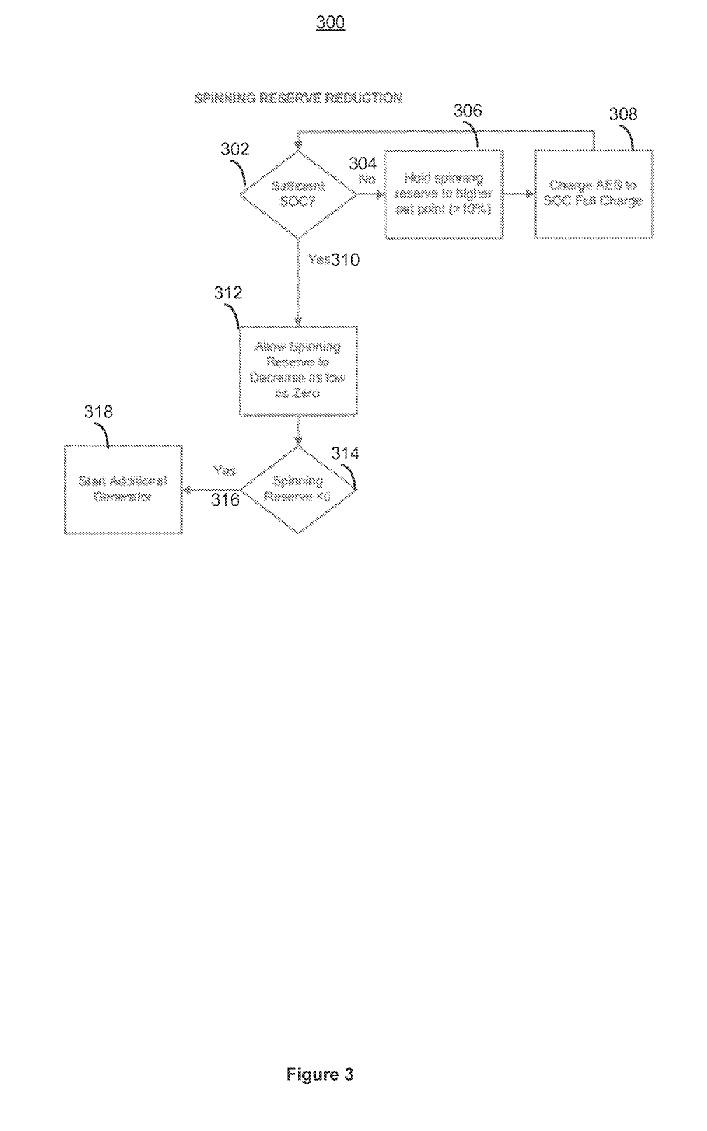

FIG. 3 is a flow chart illustrating a method for improving generator efficiency in an isolated power consumption system, in accordance with some implementations.

As shown in FIG. 3, a computer system first determines (302) a state of charge of a rechargeable battery.

When the battery is not sufficiently charged (e.g., less than 20% charged), the computer holds (306) spinning reserve of the generator to a higher set point. In other words, when the battery does not include sufficient electricity to deal with a demand/supply change (e.g., a power shortage or surplus situation), the computer maintains the generator at a lower working capacity—despite its potential inefficiency—e.g., in order to reserve power in case of a power shortage, e.g., as required by state or federal laws, as well as by contractual agreements with energy consumers.

After maintaining the generator's spinning reserve to a higher set point, the computer system charges the battery (e.g., as fast as the battery allows), and brings the battery to a full charge (308), after which the computer system can enter into a more efficient operating mode by increasing the generator's working capacity.

When the battery is sufficiently charged (e.g., more than 70% charged), the computer allows (312) spinning reserve of a generator to decrease to as low as zero. When the battery is sufficiently charged (e.g., more than 70% charged), the computer allows (312) spinning reserve of a generator to decrease to as low as zero. In other words, when the battery include sufficient electricity to deal with a demand/supply change (e.g., a power shortage or surplus situation), the computer increases working capacity of the generator, so as to place the generator in a more efficient operating mode. (As noted elsewhere in the present disclosure, a generator is more efficient when working at a higher capacity, e.g., 90% of full capacity, then at a lower capacity, e.g., 10% of full capacity.)

When the generator has reached full capacity (e.g., its spinning reserve is equal to or less than zero, 314), but still unable to meet the current power demand, an additional generator is brought online (e.g., started or fired) (316).

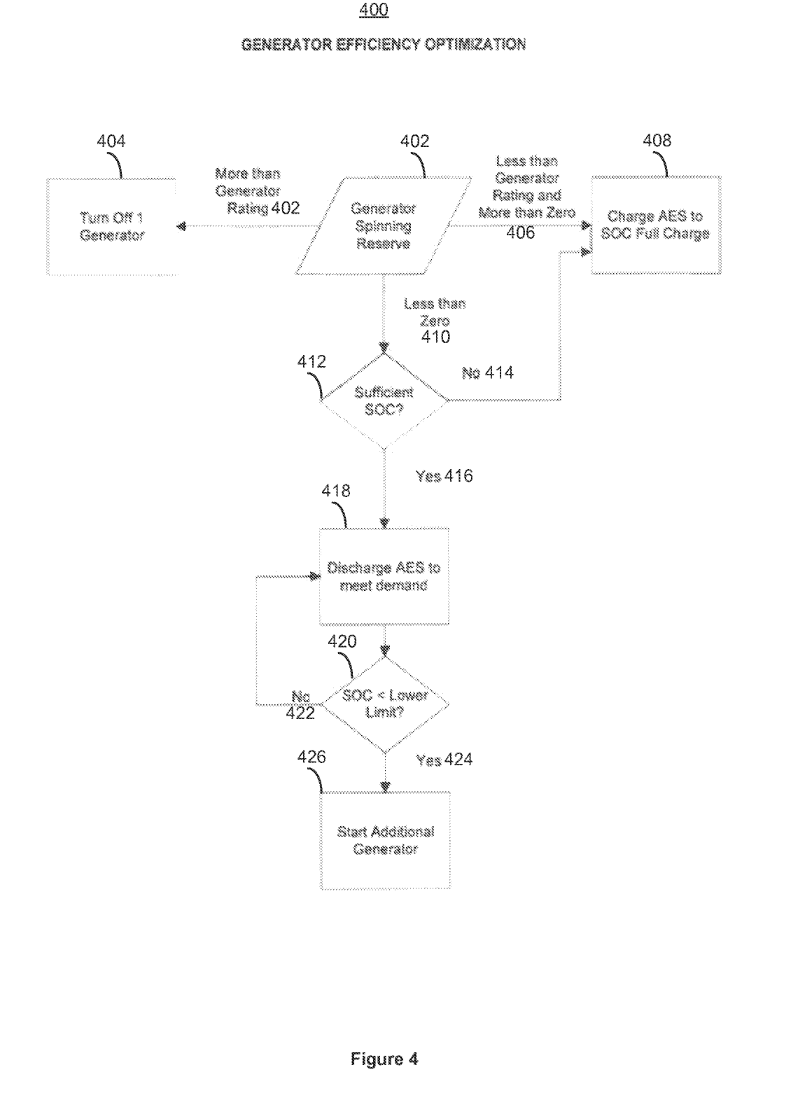

FIG. 4 is a flow chart illustrating a method for improving generator efficiency in an isolated power consumption system, in accordance with some implementations.

As shown in FIG. 4, a computer system first determines (402) a generator's spinning reserve, e.g., to identify the generator's current efficiency.

When the spinning reserve, is more than the generator's rating (e.g., when the generator is working at a very low capacity, such as at 5% of its full capacity, and is thus quite inefficient), the computer system turns off the (inefficient) generator.

When the spinning reserve, is less than the generator's rating but still more than zero 406 (e.g., when the generator is working at a very high, but still not yet full capacity, such at 98% of its full capacity), the computer system increases the generator's working capacity, thereby producing additional electricity, e.g., so as to bringing the generating into a more efficient operating mode, and stores the additional electricity into a rechargeable battery, if possible (408).

When the spinning reserve is less than zero (e.g., when the generator is exceeding its full capacity) (410), and the rechargeable battery is not sufficiently (e.g., fully) charged (414), the computer system stores a portion of the generator's power output into the rechargeable battery, if possible (408).

When the spinning reserve is less than zero (e.g., when the generator is exceeding its full capacity) (410), but the rechargeable battery is sufficiently charged (416), the computer system discharges (418) electricity previously stored into the rechargeable battery, to shoulder at least a portion of power demand, e.g., so as to avoid a generator malfunction.

The computer system continues (422) to discharge (418) electricity from the rechargeable battery, until the battery does not store enough electricity (420). When the battery starts to experience a lower charge level (424), and power demand is still not satisfactorily met, the computer system starts an additional generator.

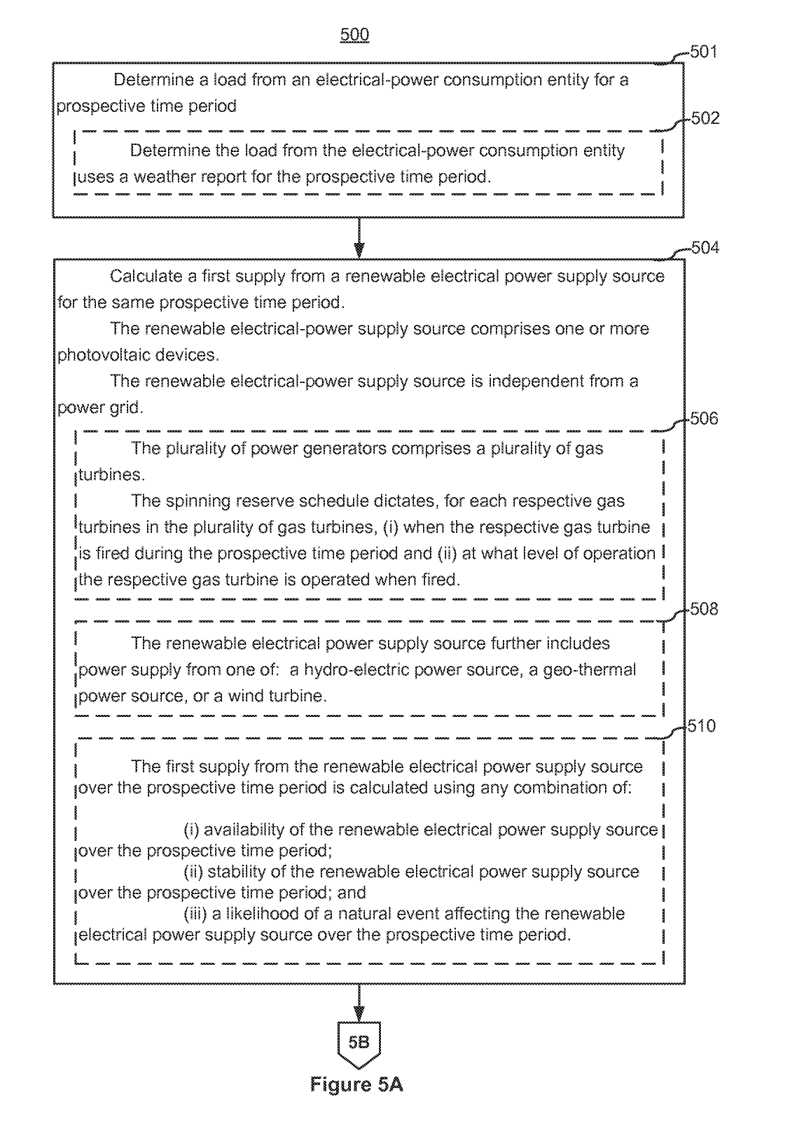

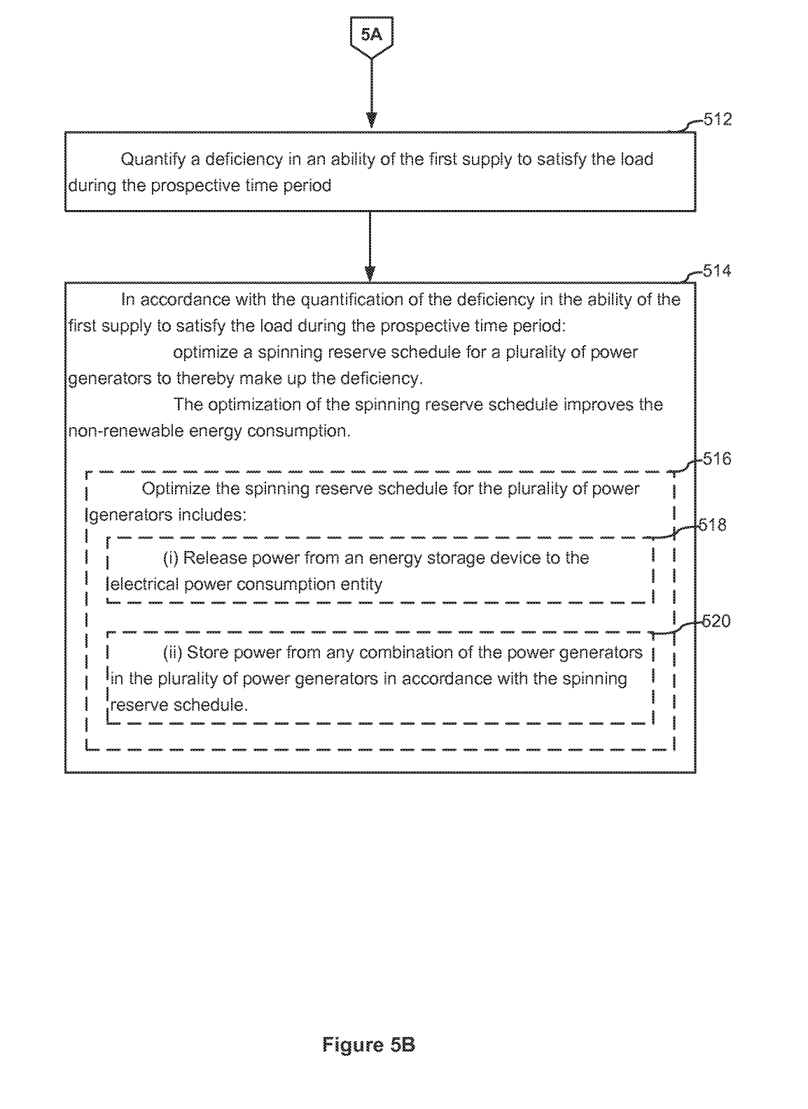

FIGS. 5A-5B are flow charts illustrating a method 500 for managing an integrated power system, e.g., implemented at the computer system 102, in accordance with some implementations.

### Demand Side

In some implementations, the computer system first determines (501) a load from an electrical-power consumption entity for a prospective time period. In some implementations, the electrical-power consumption entity is located in an isolated area (e.g., in the middle of the Death Valley National Park), and thus not connected to (e.g., unreachable by) a power grid. In some implementations, due to the unavailability of a power grid, the electrical-power consumption entity consumes power produced by renewable electrical power supply and one or more power generators. In some implementations, the electrical-power consumption entity is an island, a town, a building, a city, a compound, a school, a university campus, a penitentiary, a jail, or a waste water treatment plant, e.g., located on the top of Mt. Whitney in the Sierra mountains. In some implementations, the electrical-power consumption entity is an individual residence, e.g., located in a Nevada desert.

In some implementations, the computer system determines (502) the load from the electrical-power consumption entity uses a weather report for the prospective time period. For instance, a high temperature warning issued in a FOX NEWS weather report is used to upgrade expected power consumption by a residential area (e.g., due to a soared use of air conditioning systems) located in Half Moon Bay, Calif., where high temperature is extremely rare.

In some implementations, the computer system determines the load in accordance with an amount of power consumption by the electrical consumption entity during a first historical time period (e.g., yesterday) and a second historical time periods (e.g., the day before yesterday). e.g., so as to provide a more accurate determination/prediction. For example, power consumption statistics from two weeks ago as well as those from three weeks ago by an air port on an isolated Pacific island are used (e.g., averaged or calculated using a differential equation) to determine (e.g., predict or estimate) power consumption by the same airport during the next week. In some implementations, the first historical time period is in the range of between the past day and the past ten days and the second historical time period is in the range of between the past ten minutes and the past six hours.

### Supply Side

In some implementations, the computer system also calculates (504) a first supply from a renewable electrical power supply source for the same prospective time period is calculated. For example, the computer system calculates an amount of electricity, in terms of megawatt-hours, a renewable electrical power supply source available to an isolate island can produce for consumptions by facilities on the island, such as water treatment plant, jails, and restaurants.

In some implementations, the renewable electrical-power supply source comprises one or more photovoltaic devices, and the renewable electrical-power supply source is independent from a power grid. For example, a renewable electrical-power supply source on an isolated island is not connected to any power grid (e.g., due to the island's remote location, utility providers consider it unfeasible) and thus uses a photovoltaic farm to provide electricity to facilities on the island. In some implementations, the renewable electrical power supply further includes (508) power supply from one of: a fuel cell power source, a geyser, a wind turbine, a hydro-electric station, a nuclear power source, a geothermal power source, a fuel cell power source, a tidal power source, or an albedo power source.

In some implementations, the plurality of power generators comprises (506) a plurality of gas turbines. And the spinning reserve schedule dictates, for each respective gas turbines in the plurality of gas turbines, (i) when the respective gas turbine is fired during the prospective time period and (ii) at what level of operation the respective gas turbine is operated when fired.

For example, when the plurality of generators includes a group of gas turbines, the spinning reserve schedule includes status information of the gas turbines, such as when a gas turbine was fired or started, shutdown, or restarted, a current spinning rate (10%, 20%, and 30% of full capacity in use) and a spinning reserve (90%, 80%, and 70% of full capacity remaining) for each turbine. In some cases, the spinning reserve schedule is used to determine an optimal solution to deal with a power deficiency or excess—when to shut down a gas turbine, and how many turbines are to be shut down during a power surplus, and when to restart a turbine or to bring online an additional turbine during a power shortage.

In some implementations, the computer system quantifies (512) a deficiency in an ability of the first supply to satisfy the load during the prospective time period is then qualified. For example, after analyzing power consumption data, and power production data, received from a water treatment facility on an island, and all power generators available to provide power to the island, the computer system determines (i) that the water treatment facility will consume 1.5 megawatt during the next hour, and (ii) that the power generators will produce 0.5 megawatts, during the next hour. Accordingly, the computer system determines that a power shortage of 1 megawatt-hour is likely during the next hour, and additional power supply is probably needed.

### Efficiency Optimization

In some implementations, in accordance with the quantification of the deficiency in the ability of the first supply to satisfy the load during the prospective time period: the computer system optimizes (514) a spinning reserve schedule for a plurality of power generators is optimized to thereby make up the deficiency.

In some implementations, the optimization of the spinning reserve schedule improves the non-renewable energy consumption. For example, in some cases, power generators (e.g., gas generator) are more efficient—e.g., producing the same amount of electricity using less resources, such as gas or diesel—when operating at a higher capacity (e.g., full spinning rate) than when operating at a lower capacity (e.g., 10% of the full spinning rate), therefore, optimizing spinning reserve schedule, by e.g., maintaining the generators at full capacity most of the time, or avoid fluctuations (e.g., sudden or wide changes) of the generators' spinning rate (e.g., reducing a generator's spinning rate, then increasing the spinning rate, and again reducing the spinning rate)., would improve power (e.g., gasoline, diesel, and natural gas) consumption by the generators.

In some implementations, optimizing the spinning reserve schedule for the plurality of power generators includes (516): (i) releasing (518) power from an energy storage device (e.g., a rechargeable battery) to the electrical power consumption entity; and (ii) storing (520) power from any combination of the power generators in the plurality of power generators in accordance with the spinning reserve schedule. For example, when an unexpected demand surge occurs (e.g., due to a large number of air conditioner being turned on at the same time), rather than suddenly increasing spinning rate of a generator or bringing online an additional generator (both require changing spinning rate of a generator, existing or new, and are thus inefficient), the computer system releases electricity from a rechargeable battery, to meet the demand increase. For another example, when power demand plummets unplannedly (e.g., due to a large number of air conditioner being turned off during a storm), rather than suddenly reducing spinning rate of a generator or bringing offline an operational generator (both require changing spinning rate of a generator, and are thus inefficient), the computer system stores—now excess—power from the generator in the rechargeable battery. The excess power can then be used during a power supply deficiency, which, as described above, often results in inefficient power product (e.g., increasing a generator's spinning rate or add additional generator).

In some implementations, the energy storage device is rated for storing more than 1 megawatt-hour of power. In some implementations, the energy storage device is a lithium iron phosphate battery.

In some implementations, the first supply from the renewable electrical power supply source over the prospective time period is calculated using any combination of: (i) availability of the renewable electrical power supply source over the prospective time period, (ii) stability e.g., reliability) of the renewable electrical power supply source over the prospective time period, and (iii) a likelihood of a natural event affecting the renewable electrical power supply source over the prospective time period.

For example, the amount of electricity an off-grid electrical-power supply produces or is likely to produce during a summer season is predicted based on operational time of a specific mode of wind turbine in use (e.g., a maximum number of hours a turbine can continuously operate without malfunctioning). For example, the amount of electricity a hydro-electric station is likely to produce during a rainy season is predicted based on an amount of daily, weekly, or monthly maintenance time (during which the hydro-electric is not operational) required for a hydro-electric generator. In still another example, the amount of electricity an off-grid electrical-power supply is likely to produce during the month of February is predicted based on how likely a newly-elected president will order a shutdown of nuclear stations that have been in service for longer than 10 year, when the off-grid electrical-power supply includes such a nuclear station.

In another example, the amount of electricity the off-grid electrical-power supply is likely to produce during the summer season is predicted also based on whether a particular wind farm or a turbine included therein is likely to malfunction during the summer season, e.g., how reliable the wind farm or the turbine is likely to be, when the off-grid electrical-power supply includes the particular wind farm or the turbine.

In still another example, the amount of electricity the off-grid electrical-power supply is likely to produce during the summer season is predicted also based on likelihood of a natural event affecting the off-grid electrical-power supply over the summer season, e.g., how likely the summer reason is a windy season based on a recent or an authoritative weather forecast, when the off-grid electrical-power supply includes a wind farm; or how probable the summer reason will be a rainy season, when the off-grid electrical-power supply includes a hydro-electric station. In some implementations, calculating the predicted off-grid electrical-power supply from the off-grid electrical-power supply over the prospective time period uses a weather report for the prospective time period.

In some implementations, the natural event affecting the renewable electrical power supply source is inclement weather. In some implementations, the natural event affecting the renewable electrical power supply source is time of year or time of day, e.g., a PV farm produces more electricity during day time than during night time, and a hydro-electric station produces more electricity during a rainy season than during a dry season.

In some implementations, the load is determined in accordance with an integration or average amount of power consumption by the electrical consumption entity during two or more time periods; and the first supply is calculated in accordance with an integration or average amount of power supply by the renewable electrical power supply source during the two or more time periods.

For example, power demand (load) for two historical time periods (e.g., at 5 AM and 6 AM yesterday) are calculated (e.g., averaged or using a differential equation) to predict power demand (load) during a similar future time period (e.g., at 5:30 AM tomorrow). For instance, power supply from a PV farm for two historical time periods (e.g., at 2 PM and 3 PM yesterday) are calculated (e.g., averaged or using a differential equation) to predict power supply by the PV farm during a similar future time period (e.g., at 2:30 PM tomorrow).

In some implementations, the computer system calculates the first supply from the renewable electrical power supply source in accordance with (e.g., using) a weather report for the prospective time period. For instance, when the renewable electrical power supply source includes a wind farm and indications of inclement weather (e.g., presence or absence of a strong wind) in a weather report (e.g., a NASA weather forecast) are used to downgrade expected power contributions from the photovoltaic component.

In some implementations, the spinning reserve schedule mandates that, at any given time during the prospective time period, each respective power generator in the plurality of power generators runs at (i) a full rating or (ii) is turned off. For example, because it is inefficient to generating power using a generator at a less than full capacity (e.g., at 50% as opposed to at 100%), the spinning reserve schedule requires a binary state for a generator, either that the generator is offline (e.g., turned-off) or online at full capacity (e.g., a full rating), so as to improve generator production efficiency, and overall energy efficiency within a power system.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first supply could be termed a second supply, and, similarly, a second supply could be termed a first supply, which changing the meaning of the description, so long as all occurrences of the “first supply” are renamed consistently and all occurrences of the “second supply” are renamed consistently. The first supply, and the second supply are both supplies, but they are not the same supply.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method for improves non-renewable energy consumption comprising:
at a computer system having one or more processors and memory storing one or more programs executed by the one or more processors:
determining a load from an electrical-power consumption entity for a prospective time period;
calculating a first supply from a renewable electrical power supply source for the same prospective time period, wherein the renewable electrical-power supply source comprises one or more photovoltaic devices, and wherein the renewable electrical-power supply source is independent from a power grid;
quantifying a deficiency in an ability of the first supply to satisfy the load during the prospective time period;
in accordance with the quantification of the deficiency in the ability of the first supply to satisfy the load during the prospective time period:
optimizing a spinning reserve schedule for a plurality of power generators to thereby make up the deficiency, wherein the optimization of the spinning reserve schedule improves the non-renewable energy consumption.

2. The method of claim 1, wherein the plurality of power generators comprises a plurality of gas turbines and wherein the spinning reserve schedule dictates, for each respective gas turbines in the plurality of gas turbines, (i) when the respective gas turbine is fired during the prospective time period and (ii) at what level of operation the respective gas turbine is operated when fired.

3. The method of claim 1, wherein the renewable electrical power supply source further includes power supply from one of: a hydro-electric power source, a geo-thermal power source, or a wind turbine.

4. The method of claim 1, wherein the first supply from the renewable electrical power supply source over the prospective time period is calculated using any combination of:
(i) availability of the renewable electrical power supply source over the prospective time period,
(ii) stability of the renewable electrical power supply source over the prospective time period, and
(iii) a likelihood of a natural event affecting the renewable electrical power supply source over the prospective time period.

5. The method of claim 4, wherein the natural event affecting the renewable electrical power supply source is inclement weather.

6. The method of claim 4, wherein the natural event affecting the renewable electrical power supply source is time of year or time of day.

7. The method of claim 1, wherein, the load is determined in accordance with an amount of power consumption by the electrical consumption entity during a first historical time period and a second historical time periods.

8. The method of claim 7, wherein the first historical time period is in the range of between the past day and the past ten days and the second historical time period is in the range of between the past ten minutes and the past six hours.

9. The method of claim 1, wherein, the load is determined in accordance with an integration or average amount of power consumption by the electrical consumption entity during two or more time periods; and wherein the first supply is calculated in accordance with an integration or average amount of power supply by the renewable electrical power supply source during the two or more time periods.

10. The method of claim 1, wherein calculating the first supply from the renewable electrical power supply source uses a weather report for the prospective time period.

11. The method of claim 1, wherein determining the load from the electrical-power consumption entity uses a weather report for the prospective time period.

12. The method of claim 1, wherein optimizing the spinning reserve schedule for the plurality of power generators includes: (i) releasing power from an energy storage device to the electrical power consumption entity; and (ii) storing power from any combination of the power generators in the plurality of power generators in accordance with the spinning reserve schedule.

13. The method of claim 12, wherein the energy storage device is rated for storing more than 1 megawatt-hour of power.

14. The method of claim 12, wherein the energy storage device is a lithium iron phosphate battery.

15. The method of claim 1, wherein the electrical-power consumption entity is an individual residence.

16. The method of claim 1, wherein the electrical-power consumption entity is an island, a town, a building, a city, a compound, a school, a university campus, a penitentiary, a jail, or a waste water treatment plant.

17. The method of claim 1, wherein the spinning reserve schedule mandates that, at any given time during the prospective time period, each respective power generator in the plurality of power generators runs at (i) a full rating or (ii) is turned off.

18. A computer system, comprising:
one or more processors;
memory; and
one or more programs, wherein the one or more programs are stored in the memory and configured to be executed by the one or more processors, the one or more programs including instructions for:
determining a load from an electrical-power consumption entity for a prospective time period;
calculating a first supply from a renewable electrical power supply source for the same prospective time period, wherein the renewable electrical-power supply source comprises one or more photovoltaic devices, and wherein the renewable electrical-power supply source is independent from a power grid;
quantifying a deficiency in an ability of the first supply to satisfy the load during the prospective time period;
in accordance with the quantification of the deficiency in the ability of the first supply to satisfy the load during the prospective time period:
optimizing a spinning reserve schedule for a plurality of power generators to thereby make up the deficiency, wherein the optimization of the spinning reserve schedule improves the non-renewable energy consumption.

19. A non-transitory computer readable storage medium storing one or more programs, the one or more programs comprising instructions, which when executed by a computer system with one or more processors, cause the computer system to:
determine a load from an electrical-power consumption entity for a prospective time period;
calculate a first supply from a renewable electrical power supply source for the same prospective time period, wherein the renewable electrical-power supply source comprises one or more photovoltaic devices, and wherein the renewable electrical-power supply source is independent from a power grid;
quantify a deficiency in an ability of the first supply to satisfy the load during the prospective time period;
in accordance with the quantification of the deficiency in the ability of the first supply to satisfy the load during the prospective time period:
optimize a spinning reserve schedule for a plurality of power generators to thereby make up the deficiency, wherein the optimization of the spinning reserve schedule improves the non-renewable energy consumption.
